(19) United States
(12) Patent Application Publication
(10) Pub. No.: US 2004/0098407 A1
(43) Pub. Date: May 20, 2004

(54) Methods and systems for processing data in an automatic data proessing system

(76) Inventors: Frank Westendorf, Zeutern (DE); Bent Foss Pedersen, Jyllinge (DK); Norbert Schroeder, Bergisch-Gladbach (DE)

Correspondence Address: Finnegan, Henderson, Farabow,, Garrett & Dunner, L.L.P., 1300 I Street, N.W., Washington, DC, 20005-3315, US

(21) Appl. No.: 10/606,394

(22) Filed: Jun. 25, 2003

Related U.S. Application Data
(60) Provisional application No. 60/391,727, filed on Jun. 25, 2002.
(60) Provisional application No. 60/392,337, filed on Jun. 26, 2002.
(60) Provisional application No. 60/392,516, filed on Jun. 26, 2002.
(60) Provisional application No. 60/392,709, filed on Jun. 26, 2002.
(60) Provisional application No. 60/392,711, filed on Jun. 26, 2002.

(51) Int. Cl. G06F 9/44; G06F 17/00; G06F 7/00

(52) U.S. Cl. 707/103 Y; 717/108

(57) ABSTRACT

Methods, systems, and computer program products for processing data in an automatic data processing system are provided. One or more classes of objects are defined, wherein the classes have one or more methods for performing operations on the objects. One or more objects, each having an identifier within its class, are created of the one or more classes. A tool is created having at least one function for providing an executable solution to the one or more methods of the one or more classes, whereby at least one function is assigned to one or more methods of the one or more classes. The tool is then assigned to one of the one or more objects of the one or more classes by using the identifier of the object.

### RELATED APPLICATIONS

This application claims the benefit of provisional patent application No. 60/391,727 filed Jun. 25, 2002, and provisional patent application Nos. 60/392,337, 60/392,516, 60/392,709, and 60/392,711, which were filed Jul. 26, 2002, all of which are hereby incorporated herein by reference.

### DESCRIPTION OF THE INVENTION

1. Field of the Invention

This invention relates to electronic data processing and, more particularly, methods, computer program products, and systems for processing data in or with programming languages for the creation of software applications or in software applications itself.

2. Description of the Related Art

Software, together with automatic data processing systems comprising computers or computer systems, may be used to control business processes and to manage company information of enterprises of various kinds in any field of technology. For convenience, such software will be referred to herein generally as software for supporting business processes (“SSBP”). One example of an architecture supporting SSBP is the SAP R3 developed by SAP Aktiengesellschaft of Walldorf, Germany. The SAP R3 architecture is described in more detail in, for example, The SAP/R3 Handbook, McGraw-Hill Companies Inc., 2000, ISBN 0-07135413-1.

SSBP generally may be customized for an individual enterprise upon installation. However, over time, individual enterprises may wish to further customize the SSBP and add certain functionalities by adding additional software code to the SSBP. This process, however, has certain disadvantages. For example, any added code may have certain technical and business attributes. Technical attributes, such as type and size of fields or location of data in storage, generally relate to the system in use. Business attributes generally relate to the business procedures of the particular enterprise.

Both types of attributes generally are considered when modifying and/or customizing SSBP. In practice, however, SSBP may be modified by either technical people, such as those in the Information Technologies department, or by businesspeople, such as those in the accounting or human resources departments. The businessperson, however, may not possess the technical expertise to fully consider the technical attributes and may incorrectly make the desired modifications, thereby introducing errors into the SSBP.

Thus, there is a need for a method and/or data processing system providing a more efficient solution of the problems described above.

### SUMMARY OF THE INVENTION

In accordance with the invention, as embodied and broadly described herein, methods and systems, and computer program products consistent with the principles of the invention are provided for processing data in an automatic data processing system. One or more classes of objects are defined, wherein the classes have one or more methods for performing operations on the objects. One or more objects, each having an identifier within its class, are created of the one or more classes. A tool is created having at least one function for providing an executable solution to the one or more methods of the one or more classes, whereby at least one function is assigned to one or more methods of the one or more classes. The tool is then assigned to one of the one or more objects of the one or more classes by using the identifier of the object.

### BRIEF DESCRIPTION OF THE DRAWINGS

The accompanying drawings, which are incorporated in and constitute a part of this specification, illustrate embodiments of the invention and, together with the description, explain the principles of the invention. In the drawings,

FIG. 1 is a block diagram illustrating one exemplary software application consistent with the principles of the present invention.

FIG. 2 is a flow diagram of an exemplary process consistent with the principles of the present invention.

FIG. 3 is an exemplary computer system for implementing features consistent with the present invention.

FIG. 4 illustrates a block diagram of the components that may comprise an exemplary computer 102.

FIG. 5 is a block diagram of components of a computer systems for implementing features consistent with the present invention.

### DETAILED DESCRIPTION

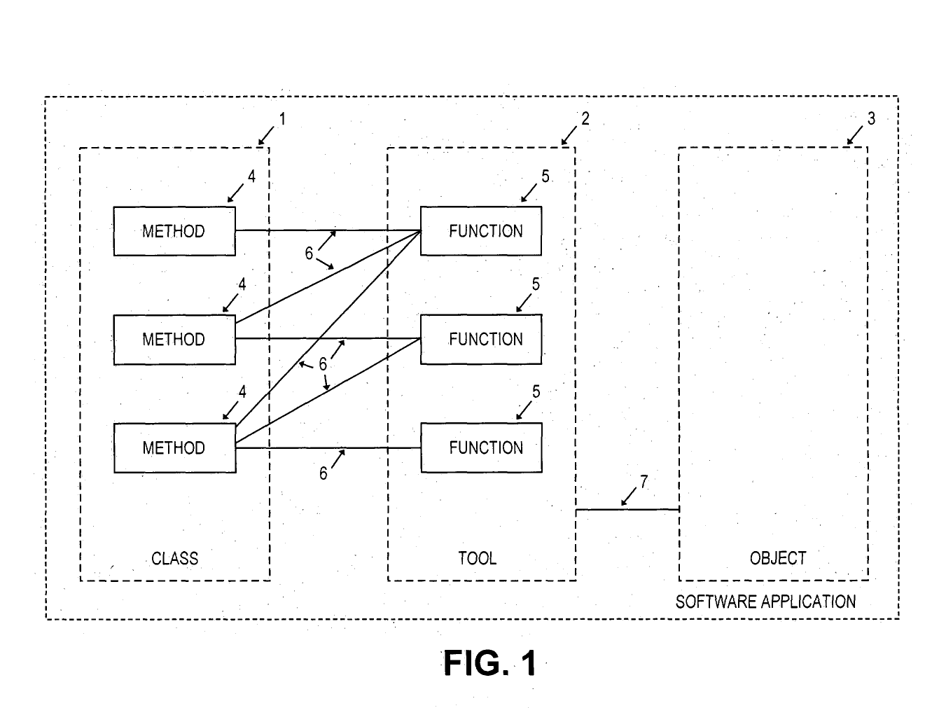

Methods, systems, and computer program products consistent with the present invention enable processing of data in an automatic data processing system. Within the scope of the invention, terms used in this specification that relate to programming languages like C, C++, JAVA, ABAP, and ABAP OO (Object-oriented) have the usual meaning as understood by those skilled in the programming arts. Exemplary embodiments of the invention are now described with reference to FIGS. 1 to 5.

FIG. 1 is a block diagram illustrating one exemplary software application consistent with the principles of the present invention. As shown in FIG. 1, software application 8 may comprise a class 1, a tool 2, and an object 3. Object 3 may be an electronic or data model of a real-world object or a real world procedure. It can be defined or implemented in any manner known to the skilled programmer. As an example, the data part of an object can be implemented as a row of a table having one ore more columns.

A class of objects 3 describes objects that have common characteristics and which may occur in the respective software application. For example, valuation objects may exist for doing valuation on, for example, insurance objects or, occasionally, of other objects. Remuneration objects may exist for calculating remuneration within a hypothetical business software application for incentive and commissions management. An object is an instance of its class. In the implementation described above, the data part of the class may be, for example, the description of the table.

A class 1 may comprise one or more methods 4. A method is a predefined functionality for performing operations on the objects. In certain embodiments, one of the methods can be applied to all instances of a particular class. One example of a class is, for example, a valuation class in which a method called, for example, “calculate valuation” may be defined.

A tool 2 may be defined as a set of functions 5 and provides a solution to the methods of one or more of the classes. A function comprises information about the executable code to call. An implementation specifies the algorithm or procedure associated with an operation. As shown in FIG. 1, tool 2 may provide a solution to class 1 by one or more of functions 5 providing information to one or more methods 4 via assignments 6. A tool 2 is assigned to an object 3 via assignment 7. This means that the tool 2 may be used by object 3.

This implementation operates within software application 8. For example, in software application 8, a tool can be created to work with valuation objects, that is, it can provide a solution to the “valuation” class. Therefore, in this example, the tool comprises a function or a reference to a function that implements the method “calculate valuation.” The tool can be assigned to objects of the “valuation” class.

As an other example, separate tools can be created for valuation objects that valuate life insurance and car insurance. In this example, both tools provide a solution to the valuation class. However, the life insurance valuation tool may be assigned to a valuation object that valuates life insurance and the other tool to a valuation object that valuates car insurance. At runtime, when the objects have to be valuated, the valuation object used for life insurance calls the executable code from the tool that designed especially for life insurance and the valuation object for car insurance calls the executable code from the tool designed especially for car insurance.

In a first embodiment of the invention, assignment of the tool to an object is performed based on a table in which a tool is associated with one or more of the identifiers (ID) of respective objects. In at least one embodiment, one tool is assigned to objects of only one class, and the ID of the tool is unique within a class. In a further exemplary embodiment, at least one function contains a reference to an executable code. In another exemplary embodiment, at least one function has a reference to a data array, in which attributes for the functions are stored. In a still further embodiment, at least one function has a reference to a data array, in which information of technical attributes for the function in a computer system, preferably in a data base management system, are stored. In certain embodiments, at least one tool comprises a reference to a data array in which attributes for at least two functions of the tool are stored. In a still further embodiment, at least one tool comprises a reference to a data array, in which information of technical attributes for at least two of the functions of the tool in a data base management system is stored. In certain embodiments, the data array is a table, stored in a computer memory, the memory being volatile or non-volatile.

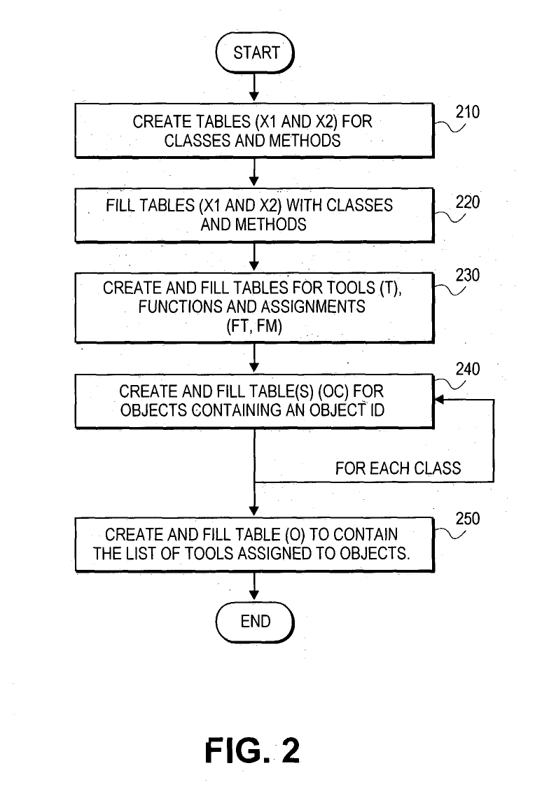

One exemplary embodiment of the invention is described in more detail below with reference to FIG. 2. The order of steps of FIG. 2 is exemplary and should not be construed as a limitation of the invention.

In one embodiment, Tables X1 and X2 can be created in order to define classes and methods (step 210). Tables X1 and X2 comprise a header line and subsequent records, each having a number of corresponding fields. The fields of the header lines define the content of the corresponding fields of the records. The entries in the fields of the records can be of any alphanumerical type, as may be appropriate in the corresponding context. As shown below, Table X1 can define several classes. One example of a Table X1, Classes, consistent with the present invention is shown below:

| Class | Descriptive Text |
|---|---|
| Val | Valuation |
| Rem | Remuneration |
| 05 | Liability |
| . . . | . . . |

One example of a Table X2, Classes and Methods, consistent with the present invention is shown here:

| Class | Method | Descriptive Text |
|---|---|---|
| Val | M1 | Calculate something |
| Val | M2 | Display something |
| Rem | M1 | Calculate something |
| Rem | M2 | Display something |
| Rem | M3 | Store something |
| 05 | M4 | Compare something |
| 05 | M2 | Display something |
| . . . | . . . | . . . |

In step 220, Tables X1 and X2 may be filled with classes and methods. Methods may be assigned to classes as shown in Table X2.

In step 230, Tables T, FT, FM for tools, and Assignments, respectively, may be created and filled. Examples are given below:

Table T for Tools:

| Tool | Descriptive Text |
|---|---|
| . . . | . . . |
| X | . . . |
| Y | . . . |
| . . . | |

Table FT for assigning functions to tools:

| Tool | Function | Descriptive Text | Executable code |
|---|---|---|---|
| X | F1 | . . . | Code 1 |
| X | F2 | . . . | Code 2 |
| Y | F1 | . . . | Code 1 |
| Y | F3 | . . . | Code 3 |
| . . . | . . . | | |

Table FM for assigning functions to methods:

| Tool | Function | Class | Method |
|---|---|---|---|
| X | F1 | Val | M1 |
| X | F2 | Val | M2 |
| X | F1 | Rem | M1 |
| Y | F3 | 05 | M2 |
| . . . | . . . | . . . | . . . |

Based on Table T, Table FT, and Table FM, Tools (T) can be defined. Functions can also be assigned to the tools (FT) and connected to the methods of several classes (FM). Functions can be easily customized by changing the executable code as indicated in table FT.

In order to define classes and to create objects, table OC may be created and filled (step 240). Table OC for objects of a class, e.g. Val:

| Object ID | Field1 | Field2 | . . . | FieldX |
|---|---|---|---|---|
| . . . | . . . | . . . | . . . | . . . |
| 75 | Value1 | Value2 | . . . | ValueX |
| . . . | . . . | . . . | . . . | . . . |

In table OC, the header and the description of the respective fields can be interpreted as being the data part of the class. The rows are the objects of the respective class, all having as common characteristics the properties as described in the fields 1 to X. In certain embodiments, the Object ID is unique within one class. Such tables may be created and filled for any class in the respective software application.

In order to assign tools to objects, a table O may be created and filled (step 250). Table O for assigning tools to objects:

| Class | Object ID | Tool |
|---|---|---|
| . . . | . . . | . . . |
| Val | 75 | X |
| Val | 76 | X |
| Val | 77 | Y |
| . . . | . . . | . . . |
| 05 | 75 | Y |

In the specific example of table O, one object can have only one tool assigned.

In one exemplary embodiment of the invention, Table FT may be modified to contain a reference to a data array, in which technical attributes used by the executable code of at least one of the functions are stored. Such technical attributes may comprise such information as information of remote systems, system settings, length of fields, etc. The technical attributes can be implemented as a data base table. Table FT may further be modified to contain a reference to a data array, in which business attributes used by the executable code of at least one of the functions are stored. Such business attributes may comprise information that is used to control the executable code with respect to a desired business logic. Again, this can be implemented as a data base table. Such attributes, irrespective of whether they are technical or business attributes, may be maintained by programs that can be called by a user, e.g. by a mouse click on a specific button on a screen, and which allow display and modification of the respective arrays.

Table FT1 shows one example of such a modification, whereby columns for business and technical attributes are added. Table FT1 also comprises references to technical and business attributes:

| | | Descr. | Executable | Technical | Business |
|---|---|---|---|---|---|
| Tool | Function | Text | code | Attributes | Attributes |
| X | F1 | . . . | Code 1 | Array FT1 | Array FB1 |
| X | F2 | . . . | Code 2 | Array FT2 | Array FB2 |
| Y | F1 | . . . | Code 1 | Array FT1 | Array FB1 |
| Y | F3 | . . . | Code 3 | Array FT3 | Array FB3 |

References to the same type of arrays may also be added to Table T. Attributes specified in the arrays in Table T, however, may be based on a tool level as shown in table T1. On the other hand, attributes specified in the arrays in Table FT may be based on a function level.

In certain embodiments, attributes on a tool level apply to all functions associated with the tool, whereas attributes defined at a function level only apply to the specific function.

As shown below, Table T1 comprises references to attributes:

| | Descriptive | Technical | Business |
|---|---|---|---|
| Tool | Text | Attributes | Attributes |
| . . . | . . . | . . . | . . . |
| X | . . . | Array TT7 | Array TB7 |
| Y | . . . | Array TT8 | Array TB8 |
| . . . | | . . . | . . . |

If the arrays are implemented as tables, the arrays can be created with the fields described in the following. In addition, the technical array at the tool level can have the following fields:

| | | | | | |
|---|---|---|---|---|---|
| Class | Tool | Attr. 1 | Attr. 2 | . . . | Attr. X |

where the fields Class and Tool can be used as key fields and the attr. 1 to attr. X are the fields that contain the attributes.

In another example, the technical array at the function level could have the following fields:

| | | | | | | | |
|---|---|---|---|---|---|---|---|
| Class | Method | Tool | Function | Attr. 1 | Attr. 2 | . . . | Attr. X |

where the fields Class, Method, Tool and Function can be used as key fields and the attr. 1 to attr. X can be the fields that contain the attributes.

The business array at the tool level can have the following fields:

| | | | | | | |
|---|---|---|---|---|---|---|
| Class | Tool | Object ID | Attr. 1 | Attr. 2 | . . . | Attr. X |

where the fields Class, Tool and Object ID can be used as key fields and the attr. 1 to attr. X can be the fields that contain the attributes.

The business array at the function level can have the following fields:

| Class | Method | Tool | Function | Object | Attr. | Attr. | . . . | Attr. X |
|---|---|---|---|---|---|---|---|---|
| | | | | ID | 1 | 2 | | |

where the fields Class, Method, Tool, Function and Object ID can be used as fields and the attr. 1 to attr. X can be the fields that contain the attributes.

In a further exemplary embodiment, table O may be modified such that one object can have more than one tool assigned. In this case, a further row may be added to the table, which may be used to decide, based on a priority parameter, the order in which the tools are used.

For example, as shown below, Table O1 may be used for assigning a function to more than one tool:

| Class | Object ID | Tool | Order of execution |
|---|---|---|---|
| . . . | . . . | . . . | |
| Val | 75 | X | |
| Val | 76 | X | 10 |
| Val | 76 | Y | 20 |
| . . . | . . . | . . . | |
| 05 | 75 | Y | |

In the example above, an object with ID 76 has the tools X and Y assigned. If a method is to be applied on the object, the method from tool X is applied first and then the method of tool Y.

In a still further exemplary embodiment, table FM may be modified such that more than one function can be assigned to one tool. In this case, a further row may be added to the table, which may be used to decide, based on a priority parameter, the order in which the functions are used.

One example of a Table FM1 for assigning more than one functions to one method is shown below:

| | | | | Order of |
|---|---|---|---|---|
| Tool | Function | Class | Method | execution |
| X | F1 | Val | M1 | 10 |
| X | F2 | Val | M1 | 20 |
| X | F1 | Rem | M2 | |
| Y | F3 | 05 | M2 | |
| . . . | . . . | . . . | . . . | |

In this example, a method M1 is assigned the functions F1 and F2 of a tool X. If the method M1 is to be applied on an object of the Val class, the function F1 from tool X is applied first and then the function F2 of tool X.

One example of an object in an SSBP application may be a valuation object that valuates life insurance. Life insurance objects may contain, for example, information that is relevant to the valuation such as, for example, the amount for which a policy holder is insured and the annual premium. The valuation object has a method that is called to do the valuation of the life insurance object and it returns as a result the value of the life insurance object.

When, during execution of an SSBP software, a method may be applied on an object by, for example, using the following exemplary pseudo-code:

/*********************************************************
START PROGRAM
...

ObjectID = “uv”. /* Using an Object having an ID “uv”
/* Call a Function Module to apply a Method as specified in
/* the Function Module on the object “uv” of the class
/* specified in the function module; X,Y,Z are parameters as
/* may apply, including objects of other classes.
CALL FUNCTION Get_and_Call_Code

(

ObjectID,
X,
Y,
Z

).

...
END PROGRAM
/*********************************************************
/* Get and call the code that is to be executed.
FUNCTION Get_and_Call_Code ( p_ObjectID, p_p1, p_p2, p_p3 )

DATA: var_class, var_method, var_code.
var_class = ‘VAL’. /* The class
var_method = ‘CALC’. /* The method
/* Get the executable code (the name of the function module)
CALL FUNCTION Get_Executable_Code

(

var_class,
var_method,
p_ObjectID,
var_function_name /* Returns the executable code

).

IF NOT (var_function_name IS INITIAL ).

/* Execute the code, i.e. apply the method on the object.
/* See the function module “Executable_Code” as example
/* of an executable code.
CALL FUNCTION var_function_name
(

var_class, /* The set of parameters is the interface
var_method, /* for the function module.
p_ObjectID,
p_p1,
p_p2,
p_p3

).

ENDIF.

ENDFUNCTION.
/*********************************************************
FUNCTION Get_Executable_Code( p_Class, p_Method, p_ObjectID,

P_Function_name )

DATA: var_Tool, var_ToolFunction.
/* Use the list of tools assigned to objects to find the
/* tool (uses table O).
CALL FUNCTION Get_Tool

(

p_Class,
p_ObjectID,
var_Tool /* Returns the tool

).

/* Use the list of functions associated to methods to find
/* the function (uses table C).
CALL FUNCTION Get_ToolFunction

(

p_Class,
p_Method,
var_Tool,
var_ToolFunction /* Returns the tool function

).

/* Get the code to execute from the information contained
/* in the tool function (uses table F).
CALL FUNCTION Get_code

(

var_Tool,
var_ToolFunction,
P_function_name /* Returns the executable code.

).

ENDFUNCTION.
/*********************************************************
/* Function module with the executable code.
/* The name of the executable code (in this case
/* “Executable_Code”) is specified as part of
/* the tool function.
FUNCTION Executable_Code( p_Class, p_Method, p_ObjectID,

P_p1, P_p2, P_p3 )

DATA: var_Attr1, var_Attr2, var_Attr3, var_Result.
/* Get the attributes stored in the technical arrays.
/* The function module gets attributes
/* specified at both the tool and function level.
CALL FUNCTION Get_Attributes_From_Technical_Array

(

p_Class, /* Class, Method and Object ID
p_Method, /* are used to find the
p_ObjectID, /* attributes in the array.
var_Attr1, /* Returns attribute 1 and
var_Attr2 /* attribute 2

).

/* Get the attributes stored in the business arrays.
/* The function module gets attributes
/* specified at both the tool and function level.
CALL FUNCTION Get_Attributes_From_Business_Array

(

p_Class, /* Class, Method and Object ID
p_Method, /* are used to find the
p_ObjectID, /* attributes in the array.
var_Attr3 /* Returns attribute 3.

).

/* Use the attributes in the execution of the code.
IF var_Attr1 = ... THEN
. . .
ELSE

IF var_Attr2 = ... THEN
. . .

var_Result = var_Attr3 * ...

. . .
ENDIF.

. . .
ENDIF.

. . .
ENDFUNCTION.
/**********************************************************

The interface to the executable code as disclosed in the above pseudo code may be disclosed to a user in order to enable him to create his own tools. The three first parameters, for example, can be used to find entries in the attribute arrays.

The principles of the present invention may be used in any type of software application. In object-oriented programming languages, a class may comprise class variables and methods, a data part with the variables and a part with the methods, such as:

CLASS CX {DATA: VAR1, . . . VARX; METHODS: M1, M2 . . . MX}.

In certain embodiments of the invention, it is now possible to achieve a comparative object-oriented behavior in a non-object-oriented development language by implementing the data part as, for example, a table and by assigning functions and methods using the principles of the present invention. Nevertheless, the present invention may also be used in object-oriented programming languages. Thus, the invention may be particularly useful, but not limited to, modeling object-oriented functionalities in non-object-oriented programming languages such as C and ABAP.

In certain embodiments, such as those related to SSBP and in the field of developing such software, the principles of the present invention may be used to separate technical attributes from business attributes of the so-called user exits, so that technical staff does not need to deal with business attributes and business people do not have to concern themselves with the technical aspects of the application.

System Architecture

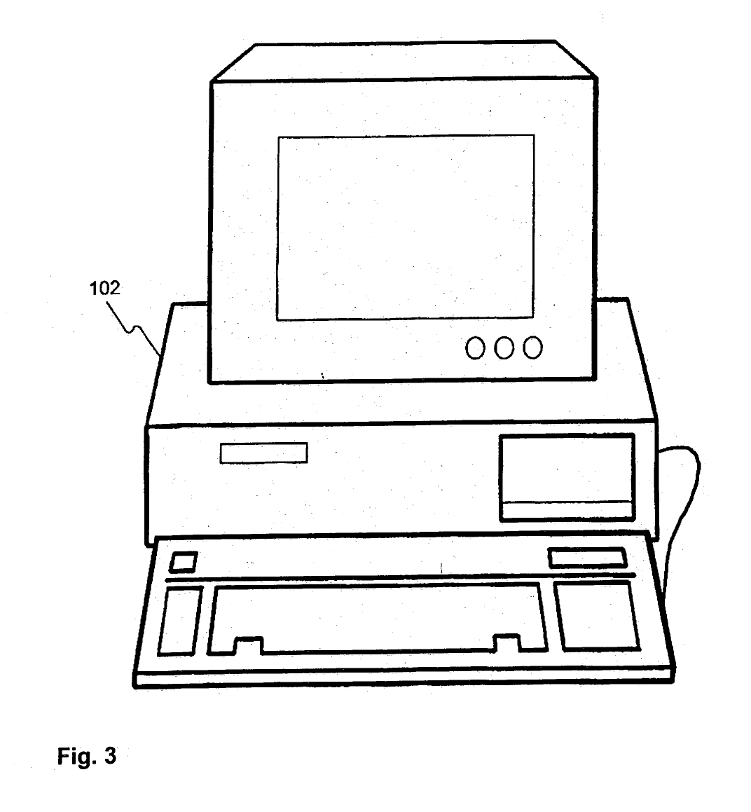

FIG. 3 is an exemplary computer system for implementing features consistent with the present invention. The components of computer 102 can be implemented through any suitable combination of hardware and software and/or firmware. A system consistent with the present invention may also comprise multiple computers 102 connected in the form of a network.

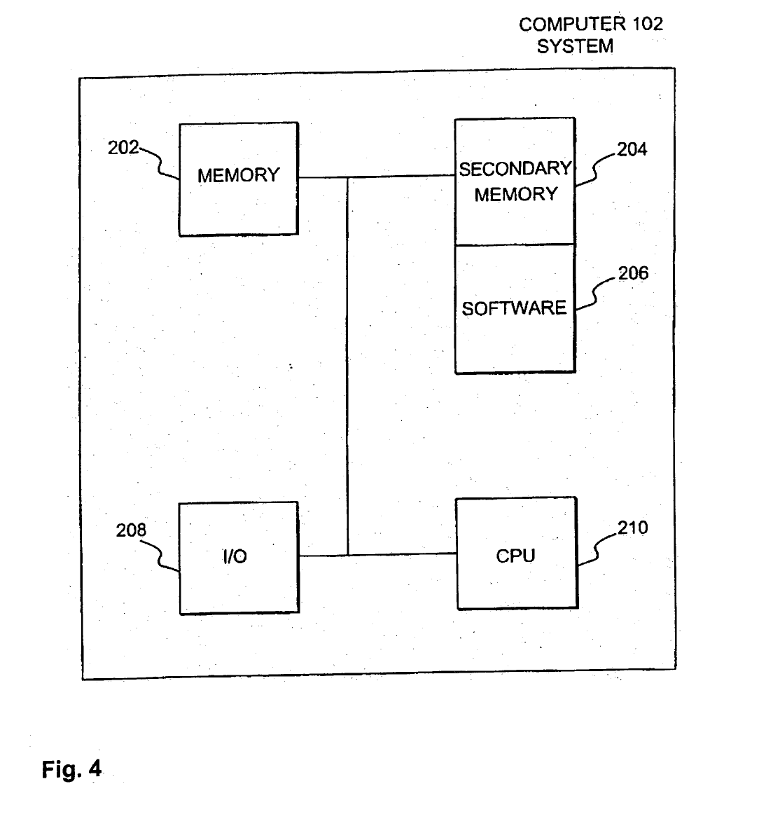

FIG. 4 illustrates a block diagram of the components that may comprise an exemplary computer 102. Computer 102 may include conventional components such as, for example, memory 202, secondary memory 204, software 206, input/output devices 208 for sending and receiving data or data objects, and/or central processing unit (CPU) 210. Software 206 may comprise a data base management system application and/or other SSBP, such as, for example, software associated with SAP R/3, for the loading and storing of data relating to the business transactions as mentioned above. Software 206 may also include instructions for interpreting this data and processing it in a manner consistent with the principles of the present invention.

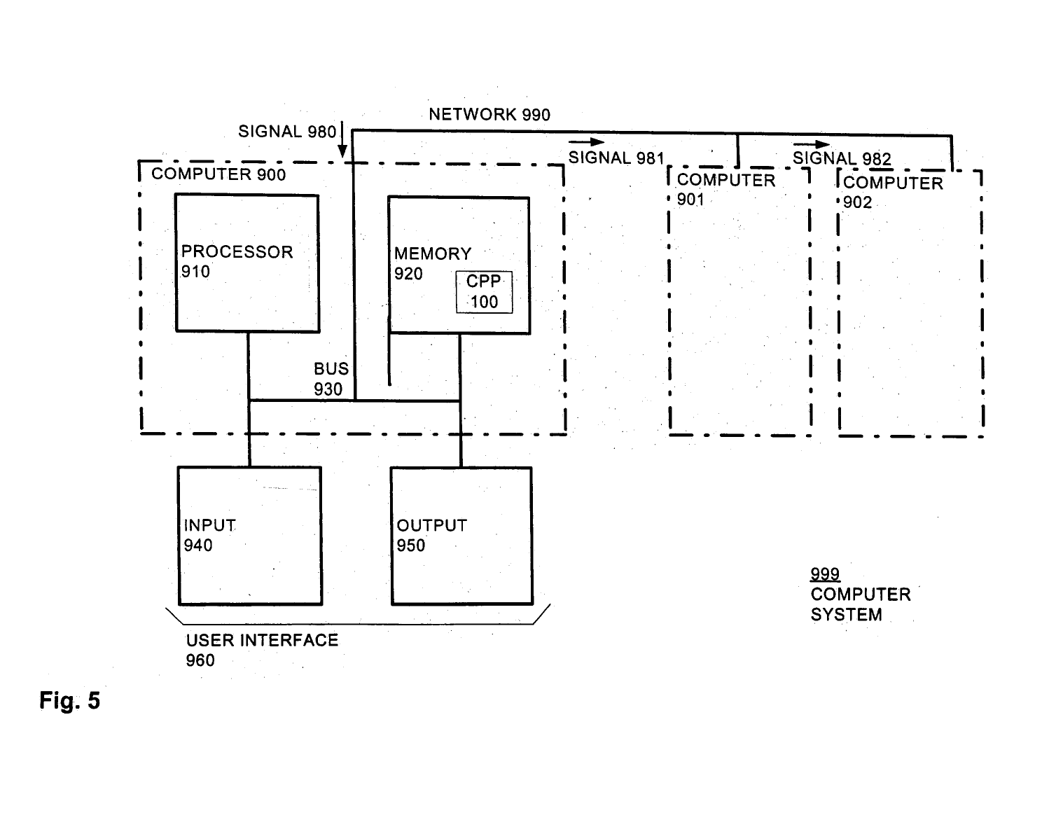

FIG. 5 illustrates a block diagram of an exemplary computer network system 999 having a plurality of computers 900, 901, 902 (or 90q, with q=0 . . . Q−1, Q any number). As shown in FIG. 5, computers 900-902 may be coupled via network 990. Computer 900 may comprise, for example, processor 910, memory 920, bus 930, and, optionally, one or more 1/0 devices and user interface 960.

Each of computers 900, 901, and 902, etc., may be, for example, a conventional personal computer (PC), a desktop computer, a handheld device, a multiprocessor computer, a pen computer, a microprocessor-based or programmable consumer electronics device, a minicomputer, a mainframe computer, a personal mobile computing device, a mobile phone, a portable or stationary personal computer, a palmtop computer or the like. Like computer 900, computers 901 and 902 may be, for example, a server, router, peer device or other common network node, and may comprise many or all of the same or similar components as computer 900.

Processor 910 may comprise, for example, a central processing unit (CPU), a micro-controller unit (MCU), digital signal processor (DSP), or the like.

Memory 920 symbolizes elements that temporarily or permanently store data and instructions. Although memory 920 is conveniently illustrated as part of computer 900, memory function can also be implemented in network 990, in computers 901 and 902 and in processor 910 itself (e.g., cache, register), or elsewhere. Memory 920 can be a read only memory (ROM), a random access memory (RAM), or a memory with other access options. Memory 920 is physically implemented by computer-readable media, such as, for example: (a) magnetic media, like a hard disk, a floppy disk, or other magnetic disk, a tape, a cassette tape; (b) optical media, like optical disk (CD-ROM, digital versatile disk—DVD); or (c) semiconductor media, like DRAM, SRAM, EPROM, EEPROM, memory stick, or by any other media, like paper.

Optionally, memory 920 may be distributed across different media. Portions of memory 920 can be removable or non-removable. For reading from media and for writing in media, computer 900 may use devices well known in the art such as, for example, disk drives and tape drives.

Memory 920 may store support modules such as, for example, a basic input output system (BIOS), an operating system (OS), a program library, a compiler, an interpreter, and a text-processing tool. Support modules consistent with the present invention may be commercially available and can be installed on computer 900 by those of skill in the art. For simplicity, these modules are not illustrated.

Memory 920 may also store computer program product (CPP) 100, which may comprise one or more software components and/or data that, when executed by processor 910, perform data processing as described above. CPP 100 can be available as source code in any programming language and/or as object code (“binary code”) in a compiled form. Persons of skill in the art can use CPP 100 in connection with any of the above support modules (e.g., compiler, interpreter, operating system).

Network 990 and the Internet both use electrical, electromagnetic or optical signals that carry digital data streams. The signals through the various networks and the signals between computer 900, 901, and 902 and network 990, are exemplary forms of carrier waves transporting the information. Computers 900, 901, and 902 can send messages and receive data, including program code, through network 990.

Input device 940 symbolizes a device that may provide data and/or instruction to computer 900. Device 940 may be, for example, a keyboard, a pointing device (e.g., mouse, trackball, cursor direction keys), microphone, joystick, game pad, scanner, disk drive, wireless receiver (e.g., with satellite dish or terrestrial antenna), a sensor (e.g., a thermometer), or a counter (e.g., goods counter in a factory.

Output device 950 symbolizes a device that may output instructions and/or data. For example, output device 950 may be a monitor or display (such as cathode ray tube (CRT), flat panel, or liquid crystal display (LCD)), speaker, printer, plotter, or vibration alert device. Output device 950 may be used to communicate with the user or other devices or computers.

Input device 940 and output device 950 can be combined in a single device. Furthermore, user interface 960 may be used to communicate between a user and input device 940 and/or output device 950 (or a combination device).

Bus 930 and network 990 provide logical and physical connections by conveying instruction and data signals. While connections inside computer 900 are conveniently referred to as “bus 930,” connections between computers 900-902 are referred to as “network 990.” Optionally, network 990 may comprise gateways, such as computers that specialize in data transmission and protocol conversion. Network 990 can be a wired or a wireless network. Network 990 may be, for example, a local area network (LAN), a wide area network (WAN), a public switched telephone network (PSTN); a Integrated Services Digital Network (ISDN), an infra-red (IR) link, a radio link, like Universal Mobile Telecommunications System (UMTS), Global System for Mobile Communication (GSM), Code Division Multiple Access (CDMA), or satellite link.

Transmission protocols and data formats are known, for example, as transmission control protocol/internet protocol (TCP/IP), hyper text transfer protocol (HTTP), secure HTTP, wireless application protocol, unique resource locator (URL), a unique resource identifier (URI), hyper text markup language HTML, extensible markup language (XML), extensible hyper text markup language (XHTML), wireless application markup language (WML), Standard Generalized Markup Language (SGML) etc.

Interfaces coupled between the elements are also well known in the art. For simplicity, interfaces are not illustrated. An interface can be, for example, a serial port interface, a parallel port interface, a game port, a universal serial bus (USB) interface, an internal or external modem, a video adapter, or a sound card.

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, although an embodiment may have been described with respect to software, systems and methods consistent with the present invention may be implemented as a combination of hardware and software, or in hardware alone. It is intended that the specification and examples be considered as exemplary only, with a true scope and spirit of the invention being indicated by the following claims.

What is claimed is:

1. A method for processing data in an automatic data processing system, comprising:
defining one or more classes of objects, the classes having one or more methods for performing operations on the objects;
creating one or more objects of the one or more classes, each object having an identifier within its class;
creating a tool having at least one function for providing an executable solution to the one or more methods of the one or more classes, whereby the at least one function is assigned to one or more methods of the one or more classes; and
assigning the tool to one of the one or more objects of the one or more classes by using the identifier of the object.

2. The method of claim 1, wherein assigning the tool to an object is performed based on a table wherein the tool is associated with one or more identifiers.

3. The method of claim 1, wherein assigning the tool to an object is performed based on a table wherein the tool is associated with one or more identifiers and wherein the tool is assigned to objects of only one class.

4. The method of claim 1, wherein the identifier is unique within its class.

5. The method of claim 1, wherein the at least one function comprises a reference to an executable code.

6. The method of claim 2, wherein the at least one function comprises a reference to an executable code.

7. The method of claim 3, wherein the at least one function comprises a reference to an executable code.

8. The method of claim 4, wherein the at least one function comprises a reference to an executable code.

9. The method of claim 1, wherein the at least one function comprises a reference to a data array, in which information relating to attributes for the at least one function are stored.

10. The method of claim 2, wherein the at least one function comprises a reference to a data array, in which information relating to attributes for the at least one function are stored.

11. The method of claim 3, wherein the at least one function comprises a reference to a data array, in which information relating to attributes for the at least one function are stored.

12. The method of claim 4, wherein the at least one function comprises a reference to a data array, in which information relating to attributes for the at least one function are stored.

13. The method of claim 1, wherein the tool comprises a reference to a data array in which information relating to attributes for at least two functions of the tool are stored.

14. The method of claim 2, wherein the tool comprises a reference to a data array in which information relating to attributes for at least two functions of the tool are stored.

15. The method of claim 3, wherein the tool comprises a reference to a data array in which information relating to attributes for at least two functions of the tool are stored.

16. A computer system for processing data in a software application, the system comprising:
a memory having program instructions;
an input means for entering data;
a storage means for storing data;
a processor responsive to the program instructions for defining one or more classes of objects, the classes having one or more methods for performing operations on the objects;
creating one or more objects of the one or more classes, each object having an identifier within its class;
creating a tool having at least one function for providing an executable solution to the one or more methods of the one or more classes, whereby the at least one function is assigned to one or more methods of the one or more classes; and
assigning the tool to one of the one or more objects of the one or more classes by using the identifier of the object.

17. The computer system of claim 16, wherein
assigning the tool to an object is performed based on a table wherein the tool is associated with one or more identifiers.

18. The computer system of claim 16, wherein
assigning the tool to an object is performed based on a table wherein the tool is associated with one or more identifiers and the tool is assigned to objects of only one class.

19. The computer system of claim 16, wherein the identifier is unique within its class.

20. The computer system of claim 16, wherein the at least one function comprises a reference to an executable code.

21. The computer system of claim 17, wherein the at least one function comprises a reference to an executable code.

22. The computer system of claim 18, wherein the at least one function comprises a reference to an executable code.

23. The computer system of claim 19, wherein the at least one function comprises a reference to an executable code.

24. The computer system of claim 16, wherein the at least one function comprises a reference to a data array, in which information relating to attributes for the at least one function are stored.

25. The computer system of claim 17, wherein the at least one function comprises a reference to a data array, in which information relating to attributes for the at least one function are stored.

26. The computer system of claim 18, wherein the at least one function comprises a reference to a data array, in which information relating to attributes for the at least one function are stored.

27. The computer system of claim 19, wherein the at least one function comprises a reference to a data array, in which information relating to attributes for the at least one function are stored.

28. The computer system of claim 16, wherein the tool comprises a reference to a data array in which information relating to attributes for at least two functions of the tool are stored.

29. The computer system of claim 17, wherein the tool comprises a reference to a data array in which information relating to attributes for at least two functions of the tool are stored.

30. The computer system of claim 18, wherein the tool comprises a reference to a data array in which information relating to attributes for at least two functions of the tool are stored.

31. A computer readable medium comprising instructions for processing data in an automatic data processing system, the medium comprising instructions for:
defining one or more classes of objects, the classes having one or more methods for performing operations on the objects;
creating one or more objects of the one or more classes, each object having an identifier within its class;
creating a tool having at least one function for providing an executable solution to the one or more methods of the one or more classes, whereby the at least one function is assigned to one or more methods of the one or more classes; and
assigning the tool to one of the one or more objects of the one or more classes by using the identifier of the object.

32. The medium of claim 31, wherein assigning the tool to an object is performed based on a table wherein the tool is associated with one or more identifiers.

33. The medium of claim 31, wherein assigning the tool to an object is performed based on a table wherein the tool is associated with one or more identifiers and wherein the tool is assigned to objects of only one class.

34. The medium of claim 31, wherein the identifier is unique within its class.

35. The medium of claim 31, wherein the at least one function comprises a reference to an executable code.

36. The medium of claim 32, wherein the at least one function comprises a reference to an executable code.

37. The medium of claim 33, wherein the at least one function comprises a reference to an executable code.

38. The medium of claim 34, wherein the at least one function comprises a reference to an executable code.

39. The medium of claim 31, wherein the at least one function comprises a reference to a data array, in which information relating to attributes for the at least one function are stored.

40. The medium of claim 32, wherein the at least one function comprises a reference to a data array, in which information relating to attributes for the at least one function are stored.

41. The medium of claim 33, wherein the at least one function comprises a reference to a data array, in which information relating to attributes for the at least one function are stored.

42. The medium of claim 34, wherein the at least one function comprises a reference to a data array, in which information relating to attributes for the at least one function are stored.

43. The medium of claim 31, wherein the tool comprises a reference to a data array in which information relating to attributes for at least two functions of the tool are stored.

44. The medium of claim 32, wherein the tool comprises a reference to a data array in which information relating to attributes for at least two functions of the tool are stored.

45. The medium of claim 33, wherein the tool comprises a reference to a data array in which information relating to attributes for at least two functions of the tool are stored.
